(19) United States
(12) Patent Application Publication
(10) Pub. No.: US 2026/0275486 A1
(43) Pub. Date: Sep. 17, 2026

(54) STEEL PRODUCT AND METHOD FOR MODIFYING STEEL PRODUCT

(71) Applicant: SUMITOMO HEAVY INDUSTRIES, LTD., Tokyo (JP)

(72) Inventor: Takashi MARUYAMA, Yokosuka-shi (JP)

(21) Appl. No.: 19/565,426

(22) Filed: Mar. 12, 2026

Related U.S. Application Data
(63) Continuation of application No. PCT/JP2024/030899, filed on Aug. 29, 2024.

(30) Foreign Application Priority Data
Sep. 19, 2023 (JP) 2023-151530

(51) Int. Cl. C23C 8/26

(52) U.S. Cl. CPC C23C 8/26

(57) ABSTRACT

A steel product includes a compound layer in which iron and nitrogen are combined and a diffusion layer in which alloy nitrides are precipitated, on a surface, in which the compound layer includes, in an outer layer portion of the compound layer, a porous layer including a plurality of cavities, and in a cross section in a depth direction, an area ratio of the cavities in the compound layer is 3.0% or less.

### CROSS-REFERENCE TO RELATED APPLICATIONS

This is a bypass continuation of International PCT Application No. PCT/JP2024/030899, filed on Aug. 29, 2024, which claims priority to Japanese Patent Application No. 2023-151530, filed on Sep. 19, 2023, which are incorporated by reference herein in their entirety.

### BACKGROUND

### Technical Field

A certain embodiment of the present invention relates to a steel product and a method for modifying a steel product.

### Description of Related Art

In the related art, a nitriding treatment is known as a surface modification technology for a steel material (for example, see the related art). In the nitriding treatment, a compound layer is formed on a surface of a sample. A porous layer having a large number of cavities due to desorption of nitrogen gas is formed on an outer layer of the compound layer.

### SUMMARY

One or more embodiments provide a steel product including: a compound layer in which iron and nitrogen are combined and a diffusion layer in which alloy nitrides are precipitated, on a surface, in which the compound layer includes, in an outer layer portion of the compound layer, a porous layer including a plurality of cavities, and in a cross section in a depth direction, an area ratio of the cavities in the compound layer is 3.0% or less.

One or more embodiments provide a method for modifying a steel product, the method including: a nitriding step of nitriding a steel material to form, on a surface of the steel material, a compound layer including a porous layer including a plurality of cavities; and a compression step of applying a compressive load to the surface of the nitrided steel material.

One or more embodiments provide a steel product including: a compound layer in which iron and nitrogen are combined and a diffusion layer in which alloy nitrides are precipitated, on a surface, in which Expression (1) is satisfied in the diffusion layer: HV>2/3×τ_{0°max} . . . (1) where τ_{0°max}: maximum horizontal shear stress [MPa] generated inside when a load is applied to the surface; and HV: Vickers hardness at a depth position at which τ_{0°max} occurs.

One or more embodiments provide a method for modifying a steel product, including: a nitriding step of nitriding a steel material to form, on a surface of the steel material, a compound layer in which iron and nitrogen are combined and a diffusion layer in which alloy nitrides are precipitated; and a compression step of applying a compressive load to the surface of the nitrided steel material, in which, in the compression step, the compressive load is applied such that Expression (1) is satisfied in the diffusion layer: HV>2/3×τ_{0°max} . . . (1) where τ_{0°max}: maximum horizontal shear stress [MPa] generated inside when a load is applied to the surface; and HV: Vickers hardness at a depth position at which τ_{0°max} occurs.

### BRIEF DESCRIPTION OF THE DRAWINGS

FIG. 1 is a flowchart showing a procedure of a method for manufacturing a steel product according to an embodiment.

FIG. 2 is a microstructure photograph of a cross section at an outermost surface of a steel material after a nitriding treatment.

FIG. 3 is a diagram showing evaluation results of an example.

FIG. 4 is a diagram showing thicknesses of a compound layer and a porous layer of examples in a depth direction.

FIG. 5 is a diagram showing a microstructure photograph of a sample cross section in a scanning electron microscope (SEM) of an example.

FIG. 6 is a diagram for describing a roller pitting test.

FIG. 7 is a diagram showing evaluation results of pitting resistance characteristics of an example.

FIG. 8 is a cross-sectional view showing an eccentric oscillation type speed reducer according to an application example of the present invention.

FIG. 9 is a diagram showing evaluation results of finite life strength of a modification example.

FIG. 10 is an S-N diagram in which test results of examples in FIG. 9 are compared with carburized materials and nitrided materials.

FIG. 11 is a graph showing a relationship between a Vickers hardness and a nitriding time when SCM440 and 31CrMoV9 are gas-nitrided at 530° C.

FIG. 12 is a component table of SCM440 and 31CrMoV9.

### DETAILED DESCRIPTION

It was found that the cavities of the porous layer act as defects and reduce fatigue strength including pitting strength.

The present invention has been made in view of the above circumstances, and it is desirable to provide improve fatigue strength of a nitrided material.

Hereinafter, an embodiment of the present invention will be described in detail with reference to the drawings.

### Method for Manufacturing Steel Product

In a method for manufacturing a steel product according to the present embodiment, surface hardening of a steel material is performed by a surface modification method including a nitriding treatment. As a result, fatigue strength including pitting strength is improved.

In the following description, a steel product (steel material) to be treated may be referred to as a “workpiece”.

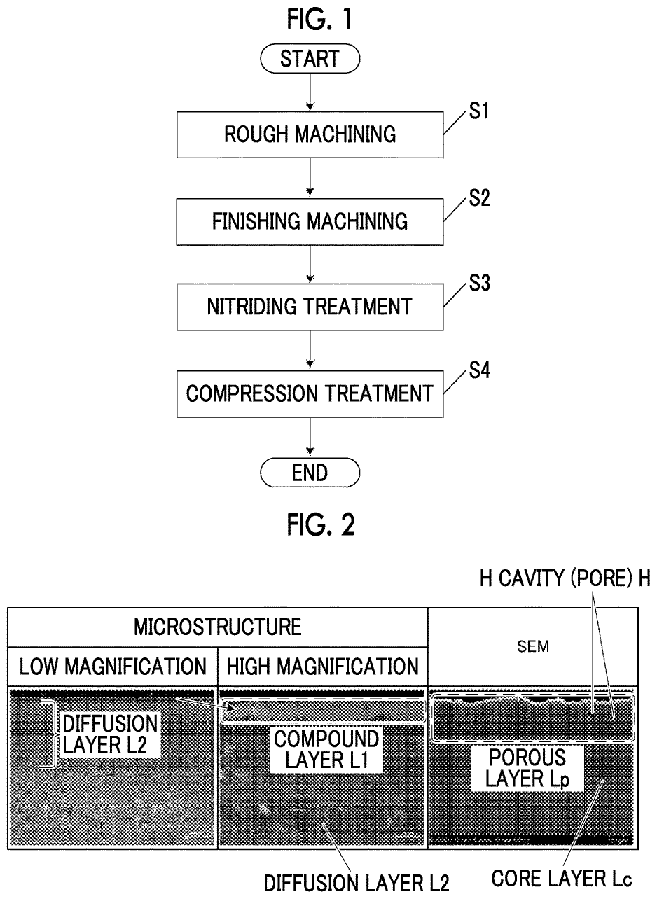

FIG. 1 is a flowchart showing a procedure of a method for manufacturing a steel product according to the present embodiment, and FIG. 2 is a microstructure photograph of a cross section at an outermost surface of a steel product after a nitriding treatment.

As shown in FIG. 1, in the method for manufacturing a steel product according to the present embodiment, for example, in a case of a workpiece of a gear member, first, the workpiece is rough-machined to a state where a predetermined finishing allowance is provided for a tooth surface (step S1).

Next, for example, the tooth surface of the workpiece is subjected to finishing machining by a polishing machine (step S2).

In addition, a necessary heat treatment or the like may be performed before and after steps S1 and S2 or between steps S1 and S2.

Next, a nitriding treatment is performed on a surface of the workpiece (for example, the tooth surface) (nitriding step) (step S3).

The nitriding treatment is a surface hardening method in which a steel-material workpiece is heated and nitrogen atoms are diffused and penetrated into an interior from a surface of the workpiece. Specifically, the workpiece is exposed to an atmosphere containing ammonia or nitrogen and is heated at a predetermined temperature for several hours. As a result, for example, as shown in FIG. 2, a compound layer L1 in which iron and nitrogen are combined is formed on the outermost surface of the workpiece, and a diffusion layer L2 in which alloy nitrides are precipitated in a structure in which nitrogen is dissolved in iron is formed on a deep layer side (toward the interior of the material). Here, the alloy nitride is a nitride in which nitrogen is combined with an element added to the steel material. The added element is, for example, Cr, Mn, or Si, but may be another element. The compound layer L1 includes a porous layer Lp including a plurality of cavities (pores) H formed in an outer layer portion, and a core layer Lc on a deeper side than the porous layer Lp.

Next, compression treatment of applying a compressive load to the surface of the workpiece (for example, the tooth surface) is performed (step S4). As a result, the cavities H of the porous layer Lp of the workpiece are closed (compression step). Here, “closing” means reducing the size of at least some of the cavities H among the plurality of cavities H of the porous layer Lp.

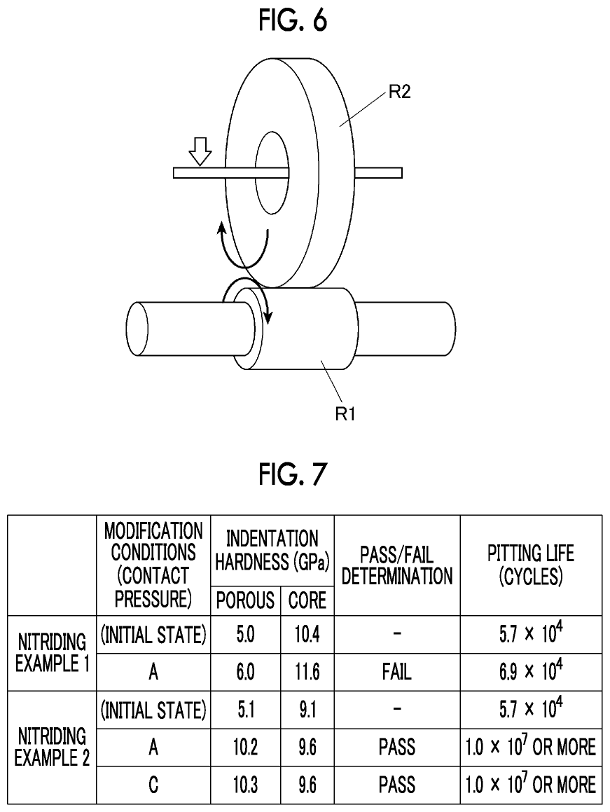

The compression treatment performed here is different from normal compression treatment in that the compression treatment does not actively peel off (break) the porous layer Lp, but instead applies a compressive load to the surface of the workpiece to close the cavities H of the porous layer Lp. As a result, the characteristics of the compound layer are retained, and the adverse effect due to the cavities generated in the porous layer is not caused. A specific method of the compression treatment is not particularly limited, and examples thereof include roll load application, shot peening, and a hot isostatic pressing (HIP) treatment. The roll load application is a method of rotating a cylindrical workpiece while pressing a load roller against the workpiece with a predetermined load. For example, the roll load application may be performed using a roller pitting tester (see FIG. 6) described later. In addition, a run-in operation of applying a load to the tooth surface or the like of the workpiece may be performed.

As a result, the cavities H of the compound layer L1 formed in the outer layer portion of the workpiece by the nitriding treatment can be closed. Therefore, the fatigue strength including the pitting strength can be improved. As a result, for example, it is possible to expect particularly high-strengthening of sliding components as a surface hardening process substituting for carburizing.

### Evaluation of Surface Modification

It has been recognized that a favorable modification effect can be obtained by setting an area ratio of the cavities H in the compound layer L1 in a cross section in a depth direction to 3.0% or less.

Hereinafter, examples in which the surface modification effect by the above-described method for manufacturing a steel product (modification method) is evaluated will be described.

### EVALUATION DETAILS

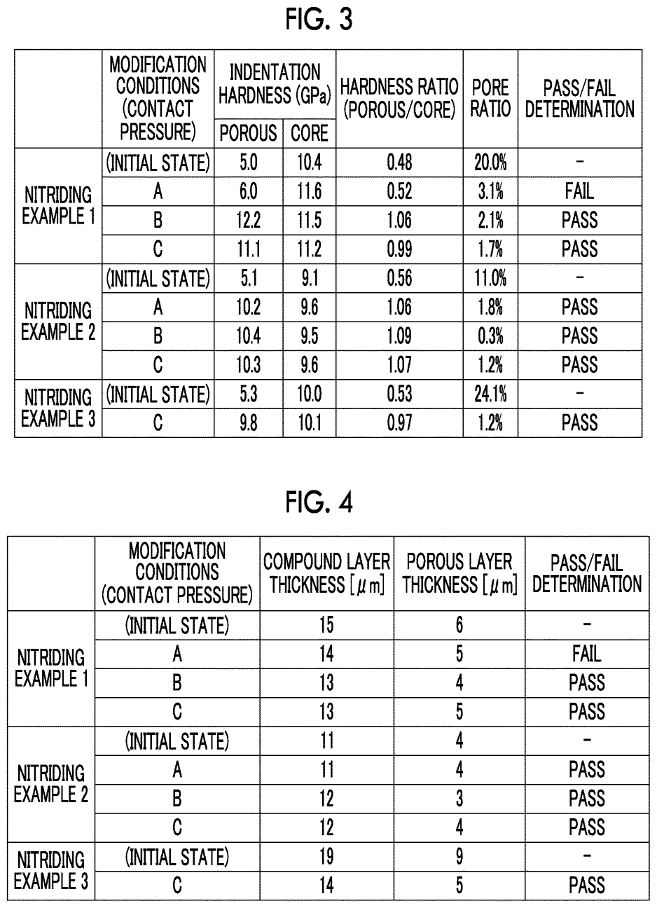

Here, samples were produced by changing the modification conditions for three nitrided materials (Nitriding Examples 1 to 3), and the “hardness ratio” and the “pore ratio” of each sample were evaluated. The modification conditions are conditions of the compressive load (contact pressure) in the compression treatment in step S4, and the evaluation was performed in three patterns of load conditions A to C (A<B<C) in Nitriding Examples 1 and 2 and in one pattern of load condition C in Nitriding Example 3 (see FIG. 3).

The “hardness ratio” was evaluated by a ratio of the indentation hardness (hardness) of the porous layer Lp and that of the core layer Lc. As a measured value of the porous layer Lp, an average value measured at a plurality of points (three or more points) within a range of 5 μm from the surface in a cross section in a depth direction (cross section substantially perpendicular to the surface) was adopted. Similarly, as a measured value of the core layer Lc, an average value measured at a plurality of points (three or more points) within a range of a predetermined depth was adopted. In the indentation hardness measurement, the measurement was performed at 2 mN using a nanoindenter such that an indentation area was 1 μm² or less.

The “pore ratio” was evaluated by an area ratio of the cavities (pores) H in the compound layer L1 in a cross section of the sample in a depth direction. The areas of the compound layer L1 and the cavities H were calculated by image analysis from an SEM (scanning electron microscope) image of the cross section of each sample in the depth direction. In the image analysis, the area ratio was calculated for the cavities of 0.01 μm² or more.

### Evaluation Results

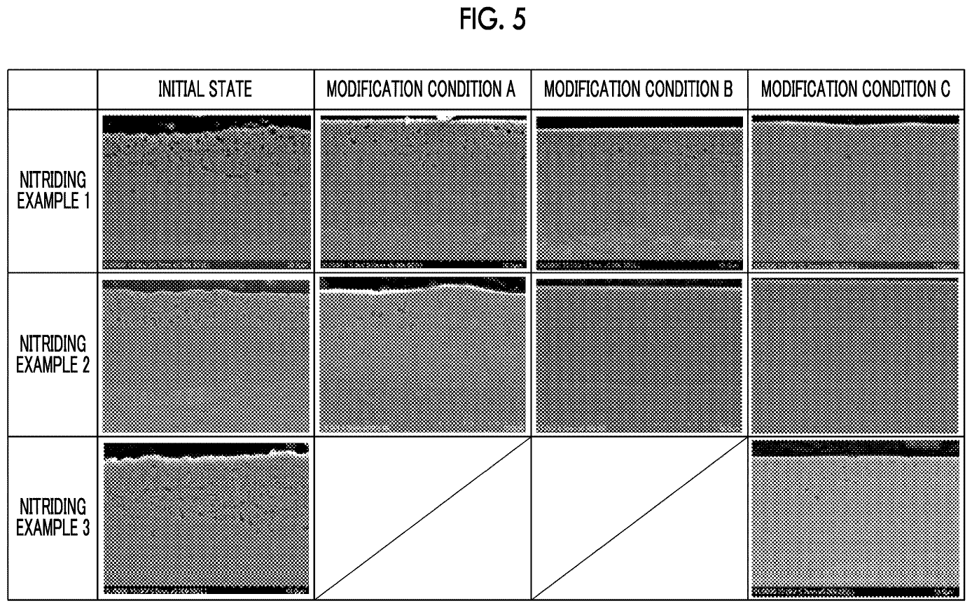

FIG. 3 shows the evaluation results, FIG. 4 shows the thicknesses of the compound layer L1 and the porous layer Lp in the depth direction, and FIG. 5 shows a microstructure photograph of a sample cross section by SEM. From FIGS. 3 to 5, the following was found:
Under all modification conditions, compared with the initial state (state after nitriding treatment), closing of the cavities H and an improvement in the pore ratio were confirmed.
In general, a more favorable modification result was obtained as the compressive load (contact pressure) increased.
In general, favorable results were obtained when the pore ratio was approximately 3.0% or less and the hardness ratio was approximately 1.0 (for example, within a range of 1.0 ±0.1).
The thickness of the compound layer L1 in the depth direction is preferably within a range of 10 to 20 μm. That is, pitting resistance characteristics are improved in a case where the thickness of the compound layer L1 in the depth direction is maintained at 10 μm or more by performing the compression treatment without actively peeling off the porous layer Lp.
The thickness of the porous layer Lp in the depth direction is preferably within a range of 3 to 10 μm.

That is, the pitting resistance characteristics are improved in a case where the thickness of the porous layer Lp in the depth direction is maintained at 3 μm or more by performing the compression treatment without actively peeling off the porous layer Lp.
The thickness ratio of the porous layer Lp to the compound layer L1 in the depth direction is preferably less than 0.5.

### Evaluation of Pitting Resistance Characteristics

Subsequently, an evaluation test for confirming a change in pitting resistance characteristics by the above-described method for manufacturing a steel material will be described.

### Evaluation Details

In the above-described example, using samples of Nitriding Example 2 under modification conditions A and C and in the initial state, each pitting resistance characteristic was evaluated by a roller pitting fatigue test.

In the roller pitting test, as shown in FIG. 6, a large roller R2 is pressed against a small roller R1 formed of a workpiece (sample) and the rollers are rotated at a predetermined slip ratio to cause pitting in the small roller R1. The main test conditions are shown below.
Slip ratio: −40%
Small roller diameter: φ26 mm
Small roller rotation speed: 1500 rpm
Large roller diameter: φ130 mm
Large roller test piece: SUJ2 (quenched and polished material)
Large roller crowning amount: 300 R
Test contact pressure: 3.02 GPa (fatigue limit contact pressure of sample: 2.96 GPa)

### Evaluation Results

The evaluation results are shown in FIG. 7. As shown in FIG. 7, under the modification condition of Nitriding Example 1, the pitting life is 6.9×10⁴, which does not change much from the initial state, and thus the pitting life is not improved. On the other hand, under the modification condition of Nitriding Example 2, the pore ratio is 3.0% or less, and the pitting life is 1.0×10⁷, and it is possible to confirm a significant improvement in the pitting life. That is, the pitting resistance characteristics can be improved by closing the cavity H.

### Modification Example of Method for Manufacturing Steel Product

In the compression treatment (compression step) of step S4 described above, it is preferable to improve the hardness of the diffusion layer L2 (and the base material) by work hardening such that Expression (1) is satisfied.

$$H V > 2 / 3 \times {τ}_{{0}^{∘} max} \qquad ( 1 )$$

Here, τ_{0°max} is the maximum horizontal shear stress [MPa] generated inside when a load is applied to the surface, and HV is the Vickers hardness at a depth position at which τ_{0°max} occurs.

As a result, the hardness of the diffusion layer L2 (and the base material) can be improved by work hardening, and the finite life strength of the workpiece can be improved. That is, according to the present modification example, it is possible to improve the finite life strength in addition to the improvement of the fatigue strength (fatigue limit).

Here, the relationship between HV and τ_{0°max} in Expression (1) is based on the relationship between the hardness and the strength in the steel material.

That is, in the steel material, it is generally known that the Vickers hardness (HV) and a tensile strength σ [MPa] have a relationship of Expression (2).

$$σ = 3 \times H V \qquad ( 2 )$$

In addition, the tensile strength σ and a shear strength τ approximately satisfy Expression (3).

$$σ = 2 \times τ \qquad ( 3 )$$

From Expressions (2) and (3), Expression (4) is obtained as the relationship between the Vickers hardness and the shear strength (maximum shear stress).

$$HV = 2 / 3 \times τ \qquad ( 4 )$$

Therefore, by work hardening the diffusion layer L2 to satisfy the above Expression (1), it is possible to suppress fracture due to the shear stress in the diffusion layer L2, and an improvement in the finite life strength can be expected.

### Evaluation of Finite Life Strength

Subsequently, an evaluation test for confirming a change in the finite life strength according to the modification example of the method for manufacturing the steel material described above will be described.

### Evaluation Details

A sample of the Example subjected to a compressive load (2.5 GPa) for the purpose of work hardening after the nitriding treatment, a sample as nitrided (Comparative Example 1), and a sample (Comparative Example 2) subjected to a compressive load (2.0 GPa) after the nitriding treatment, the compressive load being at a level such that sufficient work hardening was not obtained and Expression (1) was not satisfied, were produced, and each finite life strength (pitting life) was evaluated by a roller pitting fatigue test. In the roller pitting fatigue test, the test contact pressure was set to 3.2 GPa, and the other conditions were the same as those in the evaluation of the pitting resistance characteristics described above.

### Evaluation Results

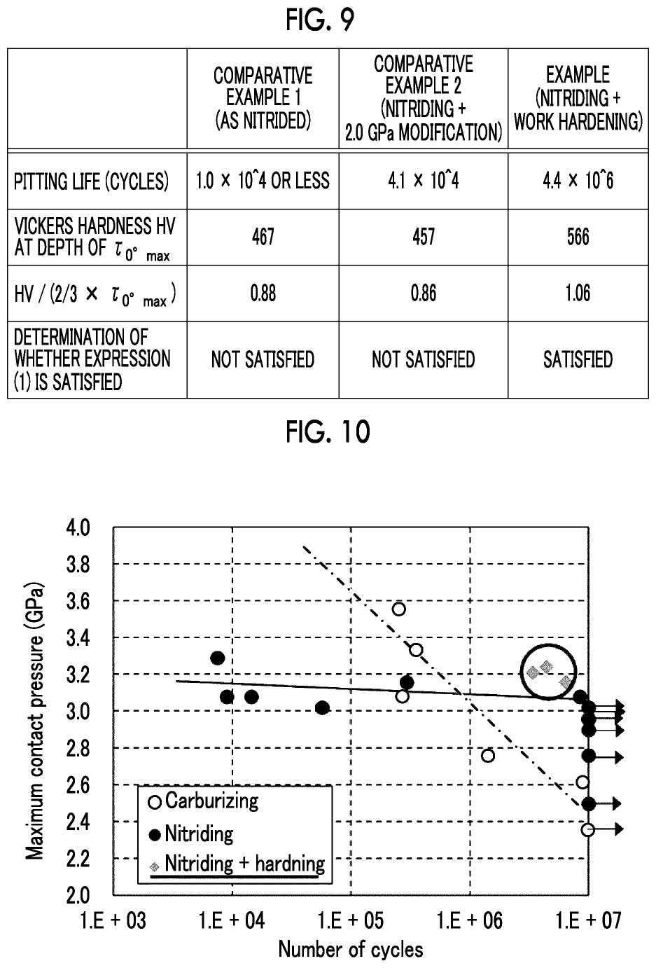

The evaluation results are shown in FIG. 9. The maximum horizontal shear stress τ_{0°max} is 809 MPa, and a depth position Dₘₐₓ at which τ_{0°max} occurs is 0.3 mm.

As shown in FIG. 9, Comparative Example 2, which was subjected to the compression treatment in a range not satisfying Expression (1), showed a longer pitting life than Comparative Example 1 without the compression treatment, but the pitting life remained only slightly improved. On the other hand, in the Example in which the diffusion layer L2 was work hardened so that Expression (1) was satisfied, the pitting life was significantly improved as compared with Comparative Example 2.

FIG. 10 shows an S-N diagram in which the test results of the Example described above are compared with those of a carburized material and a nitrided material.

As shown in this figure, it can be seen that in the Example in which the diffusion layer L2 was work hardened, the finite life strength was significantly improved as compared with the nitrided material without the compression treatment.

### Regarding Nitriding Time

Since the nitriding treatment has a shallower hardened layer depth than the carburizing treatment, simply increasing the hardened layer depth requires either a longer treatment time or the use of steel containing a large amount of expensive alloying elements, resulting in higher costs. Here, as materials that are often used after the nitriding treatment, SCM440 and 31CrMoV9 are known. 31CrMoV9 is a DIN standard material in Europe and is a nitrided steel containing more expensive alloying elements than SCM440. FIG. 12 shows a component table of SCM440 and 31CrMoV9.

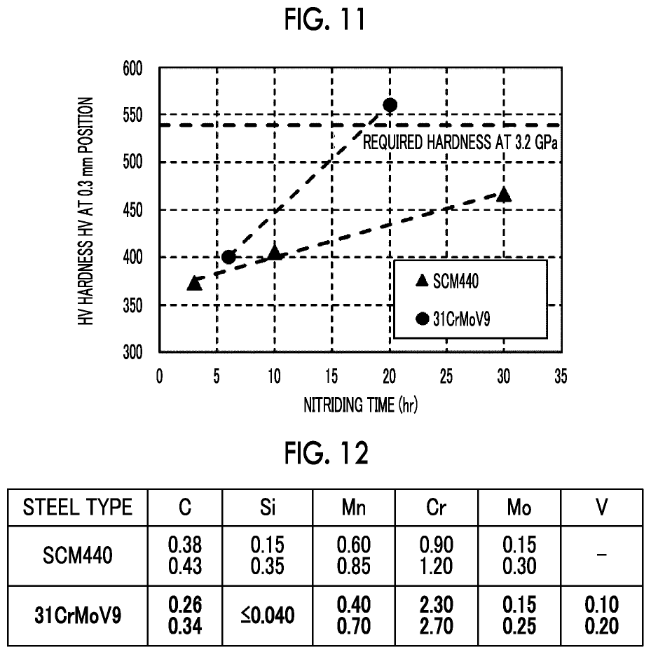

FIG. 11 is a graph showing a relationship between the Vickers hardness and the nitriding time when SCM440 and 31CrMoV 9 are gas-nitrided at 530° C. The Vickers hardness on the vertical axis of FIG. 11 is the hardness at the maximum horizontal shear stress depth position of 0.3 mm under the same conditions as those in the Example of FIG. 9. In the example shown in FIG. 11, to satisfy Expression (1) at the depth position that is the same as that under the conditions of the Example of FIG. 9, nitriding for nearly 20 hours is required even for 31CrMoV9, and nitriding for an even longer time is required for SCM440.

In this regard, in the present embodiment, the required nitriding time can be shortened by work hardening through the compression treatment, and thus a nitrided material having excellent finite life strength can be obtained at a low cost.

### OTHER

As described above, the embodiment of the present invention has been described. However, the present invention is not limited to the above-described embodiment.

For example, in the above-described embodiment, the cylindrical (columnar) workpiece has been described as an example, but the shape of the steel material (steel product) that is the workpiece is not particularly limited, and may be, for example, a flat plate shape. In addition, the type of the steel material is not particularly limited as long as it is a steel-based material that undergoes surface hardening by the nitriding treatment.

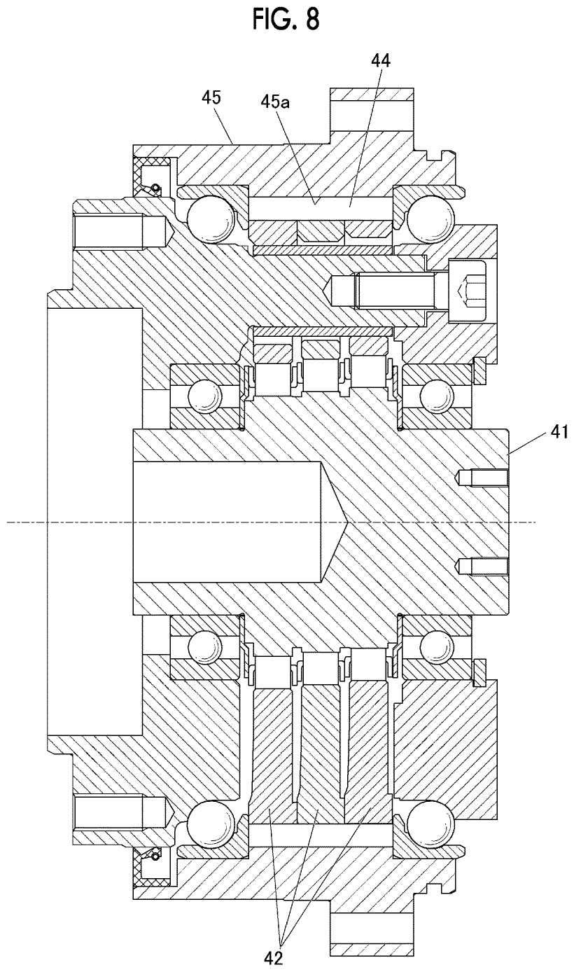

In addition, although the present invention is not particularly limited, it can be suitably applied to a component (for example, an eccentric shaft, a bearing, or the like) that is subjected to sliding fatigue under a high contact pressure. For example, as shown in FIG. 8, the present invention can be suitably applied to an eccentric shaft 41, a curved plate (external gear) 42, an internal gear (housing 45 having an outer pin 44 and an outer pin groove 45a), and the like of a small and precise speed reducer (in FIG. 8, an example of an eccentric oscillation type speed reducer). Further, the present invention is not limited to the small and precise speed reducer, and may be applied to a component of any device such as an injection molding machine or an excavator.

In addition, the details of the above-described embodiment can be appropriately changed without departing from the gist of the present invention.

As described above, the present invention is useful for improving the fatigue strength of a nitrided material.

It should be understood that the invention is not limited to the above-described embodiment, but may be modified into various forms on the basis of the spirit of the disclosure. Additionally, the modifications are included in the scope of the disclosure.

What is claimed is:

1. A steel product comprising:
a compound layer in which iron and nitrogen are combined and a diffusion layer in which alloy nitrides are precipitated, on a surface,
wherein the compound layer includes, in an outer layer portion of the compound layer, a porous layer including a plurality of cavities, and
in a cross section in a depth direction, an area ratio of the cavities in the compound layer is 3.0% or less.

2. The steel product according to claim 1, wherein a thickness of the compound layer in the depth direction is 10 to 20 μm.

3. The steel product according to claim 1, wherein a thickness of the porous layer in the depth direction is 3 to 10 μm.

4. The steel product according to claim 1,
wherein a thickness ratio of the porous layer to the compound layer in the depth direction is less than 0.5.

5. The steel product according to claim 1,
wherein the compound layer includes a core layer on a deeper side than the porous layer, and
a ratio of indentation hardness of the core layer to indentation hardness of the porous layer is within 1.0±0.1.

6. The steel product according to claim 5,
wherein a ratio between an average value of indentation hardness of the porous layer within a range of 5 μm from the surface and an average value of indentation hardness of the core layer is within 1.0±0.1.

7. The steel product according to claim 1,
wherein Expression (1) is satisfied in the diffusion layer:
$$H V > 2 / 3 \times {τ}_{{0}^{∘} max} \qquad ( 1 )$$
where
τ_{0°max}: maximum horizontal shear stress [MPa] generated inside when a load is applied to a surface; and
HV: Vickers hardness at a depth position at which τ_{0°max} occurs.

8. The steel product according to claim 7,
wherein the depth position at which τ_{0°max} occurs is 0.3 mm from the surface, and the Vickers hardness (HV) at the depth position satisfies Expression (1).

9. The steel product according to claim 1,
wherein the steel product is an eccentric shaft, a curved plate, or an internal gear used in an eccentric oscillation type speed reducer.

10. A steel product, comprising:
a compound layer in which iron and nitrogen are combined and a diffusion layer in which alloy nitrides are precipitated, on a surface,
wherein Expression (1) is satisfied in the diffusion layer:
$$HV > 2 / 3 \times {τ}_{{0}^{∘} max} \qquad ( 1 )$$
where
τ_{0°max}: maximum horizontal shear stress [MPa] generated inside when a load is applied to the surface; and
HV: Vickers hardness at a depth position at which τ_{0°max} occurs.

11. A method for modifying a steel product, comprising:
a nitriding step of nitriding a steel material to form, on a surface of the steel material, a compound layer including a porous layer including a plurality of cavities; and
a compression step of applying a compressive load to the surface of the nitrided steel material to close the cavities of the porous layer.

12. A method for modifying a steel product, comprising:
a nitriding step of nitriding a steel material to form, on a surface of the steel material, a compound layer in which iron and nitrogen are combined and a diffusion layer in which alloy nitrides are precipitated; and
a compression step of applying a compressive load to the surface of the nitrided steel material,
wherein, in the compression step, the compressive load is applied such that Expression (1) is satisfied in the diffusion layer:
$$HV > 2 / 3 \times {τ}_{{0}^{∘} max} \qquad ( 1 )$$
where
τ_{0°max}: maximum horizontal shear stress [MPa] generated inside when a load is applied to the surface; and
HV: Vickers hardness at a depth position at which τ_{0°max} occurs.
